(19) United States
(12) Patent Application Publication
(10) Pub. No.: US 2020/0211781 A1
(43) Pub. Date: Jul. 2, 2020

(54) STACKED ELEMENT AND ELECTRONIC DEVICE HAVING SAME

(71) Applicant: MODA-INNOCHIPS CO., LTD., Ansan-Si, Gyeonggi-Do (KR)

(72) Inventors: Seung Hun CHO, Siheung-Si, Gyeonggi-Do (KR); Dong Suk LEE, Incheon (KR)

(21) Appl. No.: 16/647,007

(22) PCT Filed: Jul. 12, 2018
(86) PCT No.: PCT/KR2018/007913

§ 371 Date: Mar. 12, 2020

(30) Foreign Application Priority Data
Sep. 29, 2017 (KR) 10-2017-0127912

(51) Int. Cl. H01G 4/40; H01G 4/30; H01G 4/012; H01G 4/232; H01G 4/248; H01C 7/12

(52) U.S. Cl. CPC H01G 4/40; H01G 4/30; H01C 7/12; H01G 4/232; H01G 4/248; H01G 4/012

(57) ABSTRACT

The present disclosure provides a stacked element including: a stacked body in which a plurality of sheets are stacked; a capacitor part comprising a plurality of internal electrodes formed inside the stacked body; and an external electrode provided outside the stacked body and connected to the internal electrode, wherein at least one sheet among the plurality of sheets has a different temperature coefficient of capacitance (TCC) from the remaining sheets.

### TECHNICAL FIELD

The present disclosure relates to a stacked element, and more particularly to, a stacked element including a capacitor and an electronic device having the same.

### BACKGROUND ART

Passive elements constituting an electronic circuit include resistors, capacitors, inductors, etc, and the functions and roles of these passive elements are much diversified. For example, capacitors basically function to block direct currents and pass alternating current signals. In addition, capacitors may constitute time constant circuits, time delay circuits, RC and LC filter circuits, and may also function to remove noises by themselves.

In addition, electronic circuits require overvoltage protecting elements, such as varistors, suppressors, and the like in order to protect electronic devices from an excessive voltage such as an ESD voltage applied to the electronic devices from the outside. That is, in order to prevent application of an excessive voltage no less than the driving voltage of an electronic device, an overvoltage protecting element is required.

Recently, in order to reduce the areas occupied by these components to deal with miniaturization of electronic devices, chip components can be manufactured by laminating at least two components having mutually different functions and characteristics. For example, a stacked element may be achieved by laminating a capacitor and an overvoltage protecting element into a single chip.

Meanwhile, various components are integrated in multifunction electronic devices, such as smartphones, according to the functions thereof. In addition, electronic devices are provided with antennas capable of receiving different frequency bands, such as those of various wireless LANs, Bluetooth, global positioning systems, and the like, which have diversified frequency bands for functionality, and some of the antennas may be installed as embedded antennas in housings constituting the electronic devices. For example, smartphones having metal-made frames or having metal-made cases excluding front screen display parts are increasingly used, and the metals of the cases function as antennas. Accordingly, a contactor is installed for electrical connection between an antenna installed on the case and the internal circuit of the electronic device.

For example, a stacked element having a capacitor and an overvoltage protecting part, which are provided inside a single chip, may be provided between the case and the inner circuit. Accordingly, a communication frequency is allowed to pass through using the capacitor, and an excessive voltage supplied from the outside of the electronic device may be allowed to pass through to a ground terminal of the internal circuit using the overvoltage protecting part.

Capacitors have characteristics of having capacitance varying with temperature, and this is referred to as the temperature coefficient of capacitance (hereinafter, referred to as TCC). A TCC may have a positive or negative slope according to a rise in temperature. That is, capacitors may each have a positive TCC having a slope increasing according to a rise in temperature, and a negative TCC having a slope decreasing according to a rise in temperature. Meanwhile, PCBs generally have parasitic capacitance varying with temperature, and TCCs may be different according to the lengths of respective conductive lines at the time of designing the PCBs. However, in case of a sensor or a package which is sensitive to a change in capacitance and operates by a change in capacitance, a design is required in which capacitance does not vary within a use temperature interval. However, the total capacitance is corrected using a capacitor having capacitance varying with temperature contrary to PCBs. However, actual capacitors are not provided with compositions having various TCC slopes capable of correcting all PCB environments having various designs.

Meanwhile, in order to control a TCC slope, MLCC compositions having mutually different TCCs are mixed and used to control the TCC slope. That is, ceramic compositions having a positive TCC and a negative TCC are mixed and used. However, when compositions having respective TCC characteristics are mixed, desired calculated TCCs according to addition and subtraction do not appear, but a case occurs in which unexpected TCCs appear, or there is almost no effect of mixing.

### RELATED ART DOCUMENTS

### Patent Documents

(Patent document) Korean Patent Application Laid-open Publication No. 2016-0131843

### DISCLOSURE

### Technical Problem

The present disclosure provides a stacked element having a finely adjustable TCC and an electronic device having the same.

The present disclosure also provides a stacked element in which two or more material layers having mutually different characteristics are edited and stacked and an almost theoretical TCC can be achieved, and an electronic device.

### Technical Solution

In accordance with an exemplary embodiment, a stacked element includes: a stacked body in which a plurality of sheets are stacked; a capacitor part including a plurality of internal electrodes formed inside the stacked body; and an external electrode provided outside the stacked body and connected to the internal electrode, wherein at least one sheet among the plurality of sheets has a different temperature coefficient of capacitance (TCC) from the remaining sheets.

At least one sheet among the plurality of sheets may have a different relative permittivity from the remaining sheets.

At least one sheet having the different TCC may have a different relative permittivity from the remaining sheets.

A rate of TCC change may be adjusted according to a thickness of the sheet having the different TCC and an overlap area of the internal electrode formed to be in contact with the sheet having the different TCC.

The stacked element may further include diffusion prevention electrodes formed to be in contact with the sheet having the different TCC and be spaced apart a predetermined distance from each other on a same plane.

The diffusion prevention electrodes may have, on the same plane, a spaced-apart distance greater than or equal to thickness of the remaining sheets.

A rate of TCC change may be adjusted according to a thickness of the sheet having the different TCC and an overlap area of the diffusion prevention electrode.

The stacked element may have a positive or negative rate of TCC change of no greater than 1%.

The stacked element may further include at least one functional layer provided inside the stacked body.

The functional layer may include a resistor, a noise filter, an inductor, and an overvoltage protection part.

The overvoltage protection part may include: at least two discharge electrodes; and at least one overvoltage protection layer provided between the discharge electrodes.

In accordance with another exemplary embodiment, an electronic device includes the stacked element in accordance with the exemplary embodiment.

The stacked element may include a capacitor part and an overvoltage protection part, and be provided between a conductor contactable with a user and an internal circuit.

The stacked element may transmit a communication signal and prevent electric shock or an overvoltage.

The electronic device may further include at least one conductive member provided between the conductor and the stacked element, wherein the stacked element may be connected to a ground terminal or connected to the ground terminal via a passive element.

### Advantageous Effects

In stacked elements in accordance with exemplary embodiments, an almost theoretical TCC may be achieved by editing and laminating two or more material layers having mutually different characteristics. That is, a stacked element having an almost theoretical TCC may be implemented by forming at least one sheet among the sheets of the capacitor part by using a material layer having different TCCs. In addition, the thicknesses of the sheets having different TCCs, the overlap area of an internal electrode formed with the sheet disposed therebetween, and the like are adjusted, and thus, the proportion of the capacitance due to the adjustment in the total capacitance may be adjusted, and the TCC can be finely adjusted. Accordingly, stacked elements may be manufactured which have various TCCs capable of correcting all PCB environment with various designs.

In addition, stacked elements in accordance with exemplary embodiments are each provided between a metal case and an internal circuit of an electronic device, blocks a shock voltage, and bypasses an overvoltage such as ESD to a ground terminal. That is, the stacked elements are each provided with a protection part for protecting the internal circuit by blocking a shock voltage leaking from the internal circuit and protecting an internal overvoltage, and prevent the overvoltage from being introduced into the electronic device. Accordingly, the electronic device and a user may be protected from a voltage and a current.

### BRIEF DESCRIPTION OF THE DRAWINGS

FIG. 1 is a perspective view of a stacked element in accordance with examples of exemplary embodiments;

FIG. 2 is a perspective view of a stacked element in accordance with a first example of exemplary embodiments;

FIG. 3 is a cross-sectional view of a stacked element in accordance with a second example of exemplary embodiments;

FIGS. 4 to 10 are graphs of TCC change according to temperature in related examples;

FIG. 11 is a graph of TCC change according to temperature in an example of exemplary embodiments;

FIGS. 12 to 19 are graphs of TCC change according to temperature in examples of exemplary embodiments; and

FIGS. 20 and 21 are block diagrams of stacked elements in accordance with examples of exemplary embodiments.

### DETAILED DESCRIPTION

Hereinafter, exemplary embodiments will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

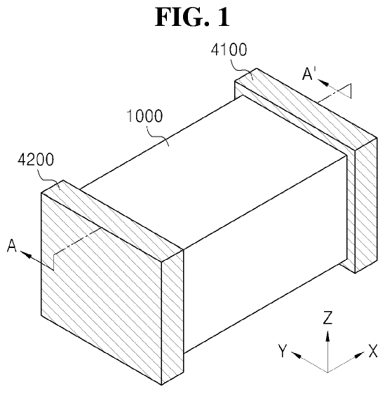

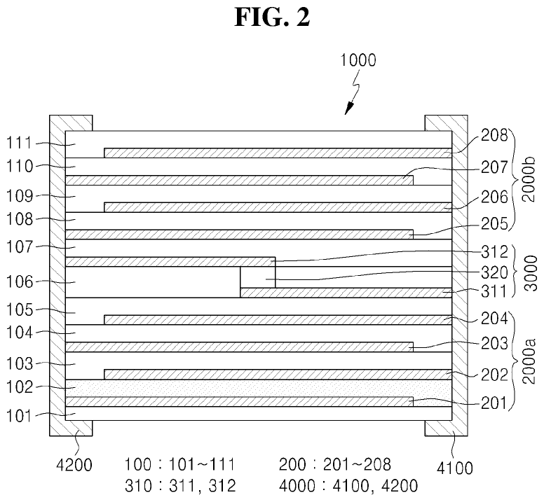

FIG. 1 is a perspective view of a stacked element in accordance with examples of exemplary embodiments and FIG. 2 is a perspective view of a stacked element in accordance with a first example of exemplary embodiments.

Referring to FIGS. 1 and 2, a stacked element in accordance with a first exemplary embodiment may include: a stacked body 1000 in which a plurality of sheets 100 (101 to 111) are stacked; at least one capacitor part 2000 (2000a and 2000b) provided inside the stacked body 1000 and provided with a plurality of internal electrodes 200 (201 to 208); and an overvoltage protecting part 3000 which is provided with at least one discharge electrode 310 (311 and 312) and an overvoltage protecting layer 320 to protect an overvoltage such as an ESD voltage. For example, the first and second capacitor parts 2000a and 2000b may be provided inside the stacked body 1000, and the overvoltage protection part 3000 may be provided therebetween. That is, the first capacitor part 2000a, the overvoltage protection part 3000, and the second capacitor part 2000b are stacked inside the stacked body 1000, so that a stacked element may be achieved. In addition, the stacked element may further include external electrodes 4000 (4100, 4200) which are formed on two mutually facing side surfaces of the stacked body 1000 and are connected to the capacitor part 2000 and the overvoltage protection part 3000. Of course, the stacked element may include at least one capacitor part 2000 and at least one overvoltage protection part 3000. That is, the capacitor part 2000 may be provided to at least one of a lower side or an upper side of the overvoltage protection part 3000, and at least one capacitor part 2000 may also be provided to upper sides and lower sides of two or more overvoltage protection parts 3000 separated from each other. Here, the overvoltage protection part 3000 may include a varistor, a suppressor, and the like. The stacked element may be provided between a conductor contactable with a user of an electronic device and an internal circuit, for example, between a metal case and an internal circuit, that is, a PCB. The stacked element functions as an antenna which supplies communication signals from the outside, and functions as an overvoltage protection element which bypasses an overvoltage such as an ESD voltage to a ground terminal of a PCB and blocks an electric shock voltage.

A structure including a capacitor part 2000 and an overvoltage protection part 3000 has been exemplified as a structure of a stacked element in accordance with an exemplary embodiment, but the stacked element of an exemplary embodiment may include various structures including a capacitor part 2000. For example, the stacked elements may include an element which includes a plurality of internal electrodes and is used solely with a capacitor, and an element in which at least one functional layer, such as a resistor, a noise filter or an inductor, and a capacitor are combined.

1. Stacked Body

The stacked body 1000 may be provided in an approximate hexahedron shape. That is, the stacked body 1000 may be provided in an approximate hexahedron shape which has predetermined lengths and widths in one direction (e.g., X-direction) and the other direction (e.g., Y-direction) which are perpendicular to each other, and has a predetermined height in the vertical direction (e.g., Z-direction). That is, when the X-direction is the formation direction of an external electrode 4000, the direction horizontally perpendicular to the X-direction may be set as the Y-direction, and the vertical direction may be set as Z-direction. Here, the length in the X-direction may be larger than the width in the Y-direction and the height in the Z-direction, and the width in the Y-direction may be the same as or different from the height in the Z-direction. When the width (Y-direction) and the height (Z-direction) are different, the width may be smaller or larger than the height. For example, the ratio of the length, width, and height may be approximately 2-5:1.0:0.3-1. That is, with respect to the width, the length may be approximately two to five times larger than the width, and the height may be approximately 0.3 to 1 times the width. However, such the sizes in the X-, Y-, and Z-directions are merely examples, and may be variously modified according to the shapes of the stacked element and the internal structure of an electronic device to which the stacked element is connected.

The stacked body 1000 may be formed such that a plurality of sheets 100 (101 to 111) are stacked. That is, the stacked body 1000 may be formed by layering a plurality of sheets 100 each having a predetermined length in the X-direction, a predetermined width in the Y-direction, and a predetermined thickness in the Z-direction. Accordingly, the length and width of the stacked body 1000 are determined by the lengths and widths of the sheets 100, and the height of the stacked body 1000 may be determined by the number of the stacked sheets 100. Meanwhile, the plurality of sheets 100 constituting the stacked body 1000 may be formed by using materials such as COG, X7R, and Y5V. The COG, X7R, and Y5V may have mutually different relative permittivities, the COG hay have a relative permittivity of no greater than 100, the X7R may have a relative permittivity of no less than 500 and less than 1000, and the Y5V may have a relative permittivity of no less than 10,000. For example, The COG may have a relative permittivity of 20-50, the X7R may have a relative permittivity of 500-4,000, and the Y5V may have a relative permittivity of 10,000-20,000. In addition, the COG, X7R, and Y5V may have mutually different TCC characteristics, the COG may have a rate of TCC change no greater than 1%, and the X7R and Y5V may have a rate of TCC change of approximately 15%. For example, the COG has a positive or negative rate of TCC change no greater than 1% at −50° C.−100° C., and the X7R and Y5V have a positive or negative rate of TCC change of 15 at −50° C.−100° C. That is, the COG, X7R, and Y5V may have positive TCCs, or negative TCCs. For example, the COG, X7R, and Y5V may have positive TCCs according to compositions forming the respective COG, X7R, and Y5V, and have negative TCCs. That is, the COG, X7R, and Y5V may have positive characteristics with which the TCCs increase according to an increase in temperature, or have negative characteristics with which the TCCs decrease according to an increase in temperature. Meanwhile, the COG may be a mixture or a composite of one or more among BaTiO₃, Nd₂O₃, TiO₂, MgCO₃, CaCO₃, ZrO₂, SrCO₃, Bi₂O₃, and ZnO. For example, the COG may be a composite of CaTiO₃, SrTiO₃, MgTiO₃, CaZrO₃, and NdTiO₃. In addition, the X7R may be a mixture of one or more among BaTiO₃, Co₃O₄, La₂O₃, Nb₂O₅, ZnO, Bi₂O₃, NiO, Cr₂O₃, BaCO₃, and WO. The relative permittivity and the rate of TCC change may be adjusted by adjusting the mixing amount or relative ratios of the compositions. Here, in an exemplary embodiment, at least any one among the plurality of sheets 100 may be formed of materials different from those of other sheets. That is, at least any one among the plurality of sheets 100 may be formed of any one among the COG, X7R, and Y5V, and the remaining sheets 100 may be formed of materials other than the materials formed into the at least any one sheet. In other words, in the exemplary embodiment, each of the plurality of sheets 100 are not formed of a mixture of two or more among the COG, X7R, and Y5V, but edited lamination is used in which the COG, X7R, and Y5V are solely used and at least one sheet is formed of a material different from those of the remaining sheet. For example, at least one sheet among the plurality of sheets 100, for example, the second sheet 102 is formed of a material having a higher relative permittivity and a large negative rate of TCC change, and the remaining sheets may be formed of a material having a lower relative permittivity and a small positive rate of TCC change. Specifically, the second sheet 102 may be formed of X7R and the remaining sheets may be formed of COG. As such, at least one sheet among the plurality of sheets 100 constituting the stacked body 1000 may be formed of a material having different relative permittivity and TCC characteristic than the other sheets, and thus may finely change the slope of the TCC. In addition, materials having different relative permittivities and TCC characteristics are used, and overlapping areas and sheet thicknesses are adjusted to adjust the proportion thereon in the total capacity, and thus, the rate of TCC change and the slope of TCC may be finely adjusted. Meanwhile, the exemplary embodiment has described that at least one sheet among the plurality of sheets 100 have a TCC different from those of the remaining sheets, but the plurality of sheets 100 may have two or more TCCs. That is, the sheets having three or more TCCs may be stacked and form a stacked body 100.

In addition, all of the plurality of sheets 100 may be formed in the same thickness, or at least any one may be formed to be thicker or thinner than the others. For example, the sheet of the overvoltage protection part 3000 may be formed in a thickness different from that of the capacitor part 2000, and the sheets formed between the overvoltage protection part 3000 and the capacitor part 2000 may be formed in a thickness different from those of other sheets. For example, the sheets between the overvoltage protection part 3000 and the capacitor part 2000, that is, the fifth and seventh sheets 105 and 107 may be formed in thicknesses which are smaller than or equal to that of the sheet of the overvoltage protection part 3000, that is, the sixth sheet 106, or may be formed in a thickness which is smaller than or equal to those of the sheets 102 to 104 and 108 to 110 between the electrodes of the capacitor part 2000. That is, the distance between the overvoltage protection part 3000 and the capacitor part 2000 may be formed to be smaller than or equal to the distance between the internal electrodes of the capacitor part 2000, or be smaller than or equal to the thickness of the overvoltage protection part 3000. Of course, the sheets 102 to 104 and 108 to 110 of the capacitor parts 2000 and 4000 may be formed in the same thickness, or any one thereof may be thinner or thicker than others. That is, a sheet, such as the second sheet 102, formed of a material having a relative permittivity and a rate of TCC change, which are different from those of other sheets, may have a thickness different from those of other sheets, and the second sheet 102 may be formed to be smaller or larger than other sheets. The thickness of a sheet, such as the second sheet 102, having a different relative permittivity and a different rate of TCC change is formed to be different from those of other sheets, and thus, the proportion of the sheet in the total capacitance may be adjusted and the TCC may thereby be adjusted. Meanwhile, the plurality of sheets 100 may be formed in a thickness of, for example, 1 μm-4,000 μm or in a thickness of no greater than 3,000 μm. That is, according to the thickness of the stacked body 1000, the thickness of each of the sheets 100 may be 1 μm-4,000 μm, and favorably be 5 μm-300 μm. In addition, according to the size of the stacked element, the thickness, the number of layers, or the like of the sheet 100 may be adjusted. That is, when applied to a stacked element having a small size, the sheet 100 may be formed in a small thickness, and when applied to a stacked element having a large size, the sheet may be formed in a large thickness. In addition, when the same number of sheets 100 are stacked, the smaller the height of the stacked element having a small size, the smaller the thickness thereof may be, and the larger the size of the stacked element, the larger the thickness thereof may be. Of course, a thin sheet may be applied to a stacked element having a large size, and in this case, the number of layers of the sheets increases. In this case, the sheet 100 may be formed in a thickness that is not broken down when applying an ESD voltage thereto. That is, even when the number of layers and the thicknesses of the sheets 100 are formed to be mutually different, at least one sheet may be formed in a thickness which is not destroyed by repetitive application of an ESD voltage.

In addition, the stacked body 1000 may further include a lower cover layer (not shown) and an upper cover layer (not shown) which are provided on the upper and lower portions of the capacitor part 2000. That is, the stacked body 1000 may include the lower cover layer and the upper cover layer respectively provided to the lowermost layer and the uppermost layer. Of course, the sheet of the lowermost layer, that is, the first sheet 101 may function as the lower cover layer and the sheet of the uppermost layer, that is, the 11th sheet 111 may function as the upper cover layer. The lower and upper cover layers which are separately provided from the sheets 100 may be formed in the same thickness. However, the upper and lower cover layers may also be formed in different thicknesses. For example, the upper cover layer may be formed to be thicker than the lower cover layer. Here, the lower and upper cover layers may be provided with a plurality of stacked magnetic sheets. In addition, non-magnetic sheets, for example, glass sheets may further be formed on the outer surfaces of the upper and lower cover layers formed of magnetic sheets, that is, on the lower surface and the upper surface of the stacked body 1000. However, the lower and upper cover layers may also be formed as glass sheets, and the surfaces of the stacked body 1000 may also be coated with polymer or glass materials. Meanwhile, the lower and upper cover layers may have thicknesses larger than that of each of the sheets 100. That is, the cover layers may have thicknesses larger than the thickness of a single sheet. Thus, when the sheets of the lowermost layer and the uppermost layer, that is, the first and 11th sheets 101 and 111, function as the lower and upper cover layers, and the first and 11th sheets may be formed to be thicker than each of the sheets 102 to 110 therebetween.

2. Capacitor Part

At least one capacitor part 2000 (2000a and 2000b) is formed inside the stacked body 1000. For example, the first and second capacitor parts 2000a and 2000b may be provided on the upper and lower portions of the overvoltage protection part 3000 interposed therebetween. However, the first and second capacitor parts 2000a and 2000b are referred to as such because the plurality of internal electrodes 200 are formed with the overvoltage protection part 3000 therebetween, and the plurality of internal electrodes 200 may be formed inside the stacked body 1000.

The capacitor parts 2000 are provided on the upper and lower portions of the overvoltage protection part 3000, and may include at least two internal electrodes and at least two sheets provided between the internal electrodes. For example, the first capacitor part 2000a may include first to fourth sheets 101 to 104 and first to fourth internal electrodes 201 to 204 respectively provided on the first to fourth sheets 101 to 104. In addition, the second capacitor part 2000b may include seventh to 10th sheets 107 to 110 and fifth to eighth internal electrodes 205 to 208 respectively provided on the seventh to 10th sheets 107 to 110. In addition, the plurality of internal electrodes 200 may each be formed to have one side connected to external electrodes 4000 (4100, 4200) formed to face each other in the X-direction, and the other side spaced apart from the external electrodes. For example, the first, third, fifth, and seventh internal electrodes 201, 203, 205 and 207 are formed to have respective predetermined area on the first, third, fifth and seventh sheets 101, 103, 107 and 109, and are formed to have one side connected to the second external electrode 4200 and the other side to be spaced apart from the first external electrode 4100. In addition, the second, fourth, sixth, and eighth internal electrodes 202, 204, 206 and 208 are formed to have respective predetermined area on the second, fourth, sixth, and eighth sheets 102, 104, 108 and 110, and formed to have one side connected to the first external electrode 4100 and the other side to be spaced apart from the second external electrode 4200. That is, the plurality of internal electrodes 200 are formed so as to be alternately connected to any one of the external electrodes 4000 and to overlap by a predetermined region with the sheets 102 to 104 and 108 to 110 therebetween. In addition, the internal electrodes 200 may be formed to have X-direction lengths and Y-direction widths which are smaller than that of the stacked body 1000. That is, the internal electrodes 200 may be formed to have lengths and widths which are smaller than those of the sheets 100. For example, the internal electrodes 200 may be formed to have lengths of approximately 10% to 90% and widths of approximately 10% to 90% of those of the stacked body 1000 or the sheets.100. In addition, the internal electrodes 200 may each be formed to have an area of approximately 10% to 90% of each of the sheets 100. Meanwhile, the plurality of internal electrodes 200 may each be formed in various shapes such as squares, rectangles, a predetermined pattern shape, a spiral shape having a predetermined width and an interval, and the like. The capacitor parts 2000 have capacitance formed between the respective internal electrodes 200, and the capacitance may be adjusted according to overlap areas of the internal electrodes 200 and the thicknesses of the sheets 100. Meanwhile, in the capacitor part 2000, at least one internal electrode may further be provided aside from the first to eighth internal electrodes 201 to 208, and at least one sheet on which the at least one internal electrode is formed may further be provided. In addition, each of the first and second capacitor parts 2000a and 2000b may also have two internal electrodes formed therein. That is, in the present exemplary embodiment, each of the internal electrodes of the first and second capacitors 2000a and 2000b are exemplarily described to have four internal electrodes formed therein, but the internal electrodes may be formed in plurality to be two or more.

The internal electrode 200 may be formed of conductive materials, for example, may be formed of a metal or a metal alloy including any one or more components among Al, Ag, Au, Pt, Pd, Ni, and Cu. In case of the alloy, for example, an alloy of Ag and Pd may be used. The internal electrodes 200 (201 to 208) may be formed in respective thicknesses of approximately 1 μm to 10 μm. Meanwhile, aluminum oxide (Al₂O₃) may be formed on a surface of Al during firing, and the internal portion thereof may be maintained as Al. That is, when forming Al on a sheet, Al comes into contact with air, and the surface of Al is oxidized in a firing process, so that Al₂O₃ is formed thereon and the internal portion is maintained as Al as it is. Thus, the internal electrodes 200 may be formed of Al having a surface coated with Al₂O₃ which forms a thin porous insulating layer. Of course, aside from Al, various metals may be used in which an insulating layer, favorably a porous insulating layer, is formed on a surface thereof. Meanwhile, the thickness of at least one region of the internal electrode 200 is small or at least one region is removed, so that a sheet is exposed. However, even when at least a region of the internal electrode 200 has a small thickness, or at least one region is removed, the entire connection state is maintained, and thus, no problem occur in electrical conductivity.

The internal electrodes 201 to 204 of the first capacitor part 2000a and the internal electrodes 205 to 208 of the second capacitor part 2000b may be formed in the same shapes and same areas, and the overlap areas may also be the same. However, the overlap area of the internal electrodes 201 and 202 formed above and below the sheet, having mutually different relative permittivity and rate of TCC change, for example, the second sheet 102, may be different from those of the other internal electrodes 203 to 208. For example, the overlap area of the first and second internal electrodes 201 and 202 may be smaller or larger than the overlap areas of the other internal electrodes 203 to 208. As such, the overlap areas of the internal electrodes formed to be in contact with sheets having different relative permittivities and rates of TCC change are adjusted, so that the proportion of the capacitance of the internal electrodes in the total capacitance may be adjusted, and the TCC may thereby be adjusted. Meanwhile, the first internal electrode 201 and the eighth internal electrode 208 may overlap the external electrode 4000, and the first to eighth electrodes 201 and 208 may be formed to be longer than the other electrodes 202 to 207. That is, end portions of the first and eighth internal electrodes 201 and 208 are formed to partially overlap the first and second external electrodes 4100 and 4200, and parasitic capacitance is formed therebetween, and thus, the first and eighth internal electrodes 201 and 208 may be formed to be, for example, approximately 10% longer than the remaining internal electrodes 202 to 207. In addition, the first and eighth electrodes 201 and 208 may also be formed such that the region overlapping the external electrodes 400 is formed to be larger than the remaining regions. For example, the overlap regions of the first and eighth internal electrode 201 and 208 with the external electrode 4000 or regions adjacent to the overlap regions may be formed approximately 10% wider than the non-overlap regions. At this point, the regions that do not overlap the external electrodes 4000 in the first to eighth electrodes 201 and 208 may have the same width as the remaining internal electrodes 202 to 209. Meanwhile, the sheets 101 to 104 of the first capacitor part 2000a and the sheets 107 to 110 of the second capacitor part 2000b may have the same thickness. However, the thickness of at least one sheet having a different relative permittiviy and a rate of TCC change, for example, the thickness of the second sheet 102 may be different from those of the other sheets. At this point, when the first sheet 101 functions as the lower cover layer, the first sheet 101 may be formed to be thicker than the other sheets. Thus, the first and second capacitor parts 2000a and 2000b may have the same capacitance. However, the first and second capacitor parts 2000a and 2000b may have different capacitance, and in this case, at least any one among the area of the internal electrodes, the overlap areas of the internal electrodes, and the thickness of the sheets may be different from each other. In addition, the internal electrodes 201 to 208 of the capacitor part 2000 may be formed to be longer than discharge electrodes 310 of the overvoltage protection part 3000, and may have areas formed to be larger.

3. Overvoltage Protection Part

The overvoltage protection part 3000 may include at least two discharge electrodes 310 (311 and 312) formed to be vertically spaced apart from each other and at least one overvoltage protection layer 320 provided between the discharge electrodes 310. For example, the overvoltage protection part 3000 may include: the sixth sheet 106; first and second discharge electrodes 311 and 312 which are respectively formed on the fifth and sixth sheets 105 and 106; and an overvoltage protection layer 320 formed to pass through the sixth sheet 106. In addition, the sixth sheet 106 between the discharge electrodes 310 may have a relative permittivity greater than 500. Here, the overvoltage protection layer 320 may be formed so as to be at least partially connected to the first and second discharge electrodes 311 and 312. The first and second discharge electrodes 311 and 312 may each be formed to have the same thickness as each internal electrode 200 of the capacitor part 2000. For example, the first and second discharge electrodes 311 and 312 may each be formed in a thickness of 1 μm to 10 μm. However, the first and second discharge electrodes 311 and 312 may each be formed thicker or thinner than each internal electrode 200 of the capacitor part 2000. The first discharge electrode 311 is formed on the fifth sheet 105 so as to be connected to the first external electrode 4100, and is formed such that an end portion thereof is connected to the overvoltage protection layer 320. The second discharge electrode 312 is formed on the sixth sheet 106 so as to be connected to the second external electrode 4200, and is formed such that an end portion thereof is connected to the overvoltage protection layer 320.

Here, the discharge electrodes 311 and 312 are formed to be connected to the same external electrode 4000 to which the adjacent internal electrode 200 are connected. That is, the first discharge electrode 311 is connected to the first external electrode 4100 similarly to the fourth internal electrode 204, and the second discharge electrode 312 is connected to the second external electrode 4200 similarly to the fifth internal electrode 205. As such, the discharge electrodes 310 and the internal electrodes 200 adjacent thereto are connected to the same external electrode 4000, so that even when the insulating sheet 100 are degraded, that is, insulation breakdown occurs, an ESD voltage is not applied to the inside of an electronic device. That is, when the discharge electrodes 310 and the internal electrodes 200 adjacent thereto are connected to the different external electrode 4000, and when insulation breakdown occurs in the insulating sheets 100, the ESD voltage applied through one external electrode 4000 flows to the other external electrode 4000 though the discharge electrodes 310 and the adjacent internal electrodes 200. For example, when the first discharge electrode 311 is connected to the first external electrode 4100 and the fourth internal electrode 204 adjacent to the first discharge electrode is connected to the second external electrode 4200, and when insulation breakdown occurs in the insulating sheets 100, a conductive path is formed between the first discharge electrode 311 and the fourth internal electrode 204, an ESD voltage applied through the first external electrode 4100 flows to the fifth insulating sheet 105 and the second internal electrode 202 in which insulation breakdown occurred, and thus may be applied to an internal circuit through the second external electrode 4200. In order to solve such the problem, the thicknesses of the insulating sheets 100 may be formed to be large, but in this case, there is a problem in that the size of the electric shock prevention element increases. However, the discharge electrodes 310 and the internal electrodes 200 adjacent thereto are connected to the same external electrode 4000, so that even when the insulating sheets 100 are degraded, that is, insulation breakdown occurs, an ESD voltage is not applied to the inside of an electronic device. In addition, the application of the ESD voltage may be prevented even without forming the insulating sheet 100 to have a large thickness.

Meanwhile, the regions contacting the overvoltage protection layer 320 of the first and second discharge electrodes 311 and 312 may each be formed to have a size equal to or smaller than the overvoltage protection layer 320. In addition, the first and second discharge electrodes 311 and 312 may be formed to completely overlap without deviating from the overload protection layer 320. That is, the edges of the first and second discharge electrodes 311 and 312 may form components perpendicular to the edge of the overvoltage protection layer 320. Of course, the first and second discharge electrodes 311 and 312 may be formed to overlap a portion of the overvoltage protection layer 320. For example, the first and second discharge electrodes 311 and 312 may each be formed to overlap approximately 10% to 100% of the horizontal surface area of the overvoltage protection layer 320. That is, the first and second discharge electrodes 311 and 312 are not formed to deviate from the protection layer 320. Meanwhile, one region contacting the protection layer 320 in the first and second discharge electrodes 311 and 312 may be formed to be larger than the region which does not contact the overvoltage protection layer 320.

The overvoltage protection layer 320 may be formed in a predetermined region, for example, in a central portion of the sixth sheet 106 and connected to the first and second discharge electrodes 311 and 312. At this point, the overvoltage protection layer 320 may be formed to at least partially overlap the first and second discharge electrodes 311 and 312. That is, the overvoltage protection layer 320 may be formed to overlap 10% to 100% of the horizontal surface areas of each of the first and second discharge electrodes 311 and 312. The overvoltage protection layer 320 may include pores formed in a predetermined region of the sixth sheet 106. That is, a vertically penetrating through-hole may be formed in the predetermined region, for example, in the central region of the sixth sheet 106 and may function as the overvoltage protection layer 320. The overvoltage protection layer 330 may be formed in a diameter of 100 μm to 500 μm and a thickness of approximately 10 μm to 50 μm. At this point, the smaller the thickness of the overvoltage protection layer 320, the lower a discharge start voltage. The overvoltage protection layer 320 may also be formed on at least one sheet 100. That is, the overvoltage protection layer 320 may be formed on at least one, for example, two respective stacked sheets 100, and the discharge electrodes may be formed on the respective sheets 100 so as to be spaced apart from each other, and be connected to the overvoltage protection layer 320.

Meanwhile, the overvoltage protection layer 320 may include an overvoltage protection material. That is, the overvoltage protection material is embedded into the pores formed in the sixth sheet 106, so that the overvoltage protection layer 320 may also be formed. The overvoltage protection material may include at least one among a porous insulating material having a plurality of pores and a conductive material. Accordingly, the overvoltage protection layer 320 may include at least one among a void, a porous insulating material and a conductive material. That is, the inside of the overvoltage protecting layer 320 may solely be formed of only a void, and at least one among the porous insulating material and the conductive material may be formed in at least some pores. At this point, at least a portion of the void, the porous insulating material and the conductive materials may be formed while forming layers. For example, the overvoltage protection layer 320 may be formed in a stacked structure of a conductive material, a porous insulating material, a void, a porous insulating material, and a conductive material. Meanwhile, the porous insulating materials may be formed of a discharge inducing material and may function as an electrical barrier. Insulating ceramic having a relative permittivity of 500-50,000 may be used as the porous insulating material. For example, the insulating ceramic may be formed by using a mixture including one or more among dielectric material powder such as MLCC, ZrO, ZnO, BaTiO₃, Nd₂O₅, BaCO₃, TiO₂, Nd, Bi, Zn or Al₂O₃. The porous insulating material has a plurality of pores having sizes of approximately 1 nm to 5 μm, and may have porosity of 30-80%. At this point, the shortest distance between the pores may be approximately 1 nm to 5 μm. That is, the porous insulating layer is formed of an electrical insulating material through which current cannot flow, but since the pores are formed, current can flow through the pores. At this point, the larger the size of the pores or the porosity, the lower the discharge start voltage may be, and conversely, the smaller the size of the pores or the porosity, the higher the discharge start voltage may be. In addition, the porous insulating material 322 may be formed to have lower resistance than those of the sheets due to micro pores, and a partial discharge may be achieved through the micro pores. Meanwhile, the conductive material has predetermined resistance and may allow current to flow therethrough. For example, the conductive material may be a resistive body having several Ω to several hundred MΩ. When an overvoltage such as an ESD voltage or the like is introduced, the conductive material lowers an energy level and prevents the occurrence of structural destruction of a stacked element due to the overvoltage. That is, the conductive material functions as a heat sink which converts electrical energy to thermal energy. This conductive material may be formed by using conductive ceramic and a mixture including one or more among La, Ni, Co, Cu, Zn, Ru, Ag, Pd, Pt, W, Fe or Bi may be used for the conductive ceramic.

4. External Electrode

The external electrodes 4000 (4100 and 4200) may be provided on two surfaces facing each other outside the stacked body 1000. For example, the external electrodes 4000 may be formed on two surfaces of the stacked body 1000 which face each other in the X-direction, that is, in the lengthwise direction. In addition, the external electrodes 4000 may be connected to the internal electrodes 200 and the discharge electrodes 310 inside the stacked body 1000. At this point, any one of the external electrodes 4000 may be connected to an internal circuit such a printed circuit board inside an electronic device, and the other may be connected to the outer portion of the electronic device, for example, to a metal case. For example, the first external electrode 4100 may be connected to the inter circuit, and the second external electrode 4200 may be connected to the metal case. In addition, the second external electrode 4200 may be connected to the metal case via, for example, a contactor or a conductive gasket.

Such external electrodes 4000 may be formed through various methods. That is, the external electrode 4000 may be formed through an immersing or printing method using a conductive paste, or may also be formed through various methods such as deposition, sputtering, plating, or the like. Meanwhile, the external electrodes 4000 may be formed to extend to surfaces in the Y-direction or the Z-direction. That is, the external electrodes 4000 may be formed to extend from two respective surfaces facing each other in the X-direction to four respective surfaces adjacent to the two respective surfaces. For example, in case of immersing in a conductive paste, the external electrodes 4000 may be formed not only on the two respective surfaces facing in the X-direction, but also on the front surface and the rear surface in the Y-direction, and the upper surface and the lower surface in the Z-direction. In comparison, in case of being formed through a method such as printing, deposition, sputtering, plating, or the like, the external electrodes 4000 may be formed on two respective surfaces in the X-direction. That is, the external electrodes 4000 may be formed not only on one side surface mounted on the printed circuit board and the other side surface connected to the metal case, but also on the other regions according to formation methods or process conditions. Such the external electrodes 4000 may be formed of a conductive metal, and one or more metals selected from the group consisting of, for example, gold, silver, platinum, copper, nickel, palladium, and an alloy thereof. At this point, at least a portion of the external electrodes 4000 connected to the internal electrodes 200 and the discharge electrodes 310, that is, a portion of the external electrodes 4000 which are formed on at least one surface of the stacked body 1000 and connected to the internal electrodes 200 and the discharge electrodes 310, may be formed of the same material as the internal electrodes 200 and the discharge electrodes 310. For example, when the internal electrodes 200 and the discharge electrodes 310 are formed by using copper, at least some regions of the external electrodes 4000 may be formed by using copper, the regions contacting the internal electrodes and the discharge electrodes. At this point, copper may be formed through an immersing or printing method using a conductive paste as described above, or be formed through a method of deposition, sputtering, plating, or the like. Favorably, the external electrodes 4000 may be formed by plating. In order to form the external electrodes 4000 through a plating process, seed layers are formed on the upper and lower surfaces of the stacked body 1000, then plated layers are formed from the respective seed layers, and thus, the external electrodes 4000 may be formed. Here, at least portions, of the external electrodes 4000, connected to the internal electrode 200 and the discharge electrode 310 may be the entire side surfaces of the stacked body 1000 on which the external electrodes 4000 are formed, or may also be partial regions.

In addition, the external electrodes 4000 may each further include at least one plated layer. The external electrodes 4000 may each be formed in a metal layer of Cu, Ag, or the like, and at least one plated layer may also be formed on the metal layer. For example, the external electrodes 4000 may each be stacked and formed by laminating a copper layer, a Ni-plated layer, and Sn or Sn/Ag-plated layer. Of course, in the plated layer, a Cu-plated layer and a Sn plated layer may be stacked, and a Cu-plated layer, a Ni-plated layer, or Sn-plated layer may also be stacked. In addition, the external electrodes 4000 may be formed by mixing metal powder with multi-component-based glass frits having a main component of, for example, 0.5-20% of Bi₂O₃ or SiO₂. At this point, the mixture of the glass frits and metal powder may be formed in a paste form and be applied to the two surfaces of the stacked body 1000. As such, by including the glass frits in the external electrodes 4000, tight adhesion between the external electrodes 4000 and the stacked body 100 may be improved, and the contact reaction of the electrodes inside the stacked body 1000 may be improved. In addition, a glass-containing conductive paste is applied, at least one plated layer is then formed on the paste, and thus, the external electrodes 4000 may be formed. That is, a metal layer including glass is formed, and at least one plated layer is formed on the metal layer, and thus, the external electrodes 4000 may be formed. For example, the external electrodes 4000 may be formed such that a layer including glass frits and at least any one among Ag and Cu is formed, and a Ni-plated layer and a Sn-plated layer may then be sequentially formed through electrolytic or electroless plating. At this point, the Sn-plated layer may be formed to have the same thickness as or greater thickness than the Ni-plated layer. Of course, the external electrodes 4000 may also be formed only by at least one plated layer. That is, the external electrodes 4000 may also be formed by forming at least one plated layer using a plating process at least once without applying a paste. Meanwhile, the external electrodes 4000 may be formed in a thickness of 2 μm-100 μm, the Ni-plated layer may be formed in the thickness of 1 μm-10 μm, and the Sn or Sn/Ag plated layer may be formed in a thickness of 2 μm-10 μm.

Meanwhile, the external electrodes 4000 may be formed such that a predetermined portion thereof overlap the internal electrodes 200 connected to the external electrodes 4000 different from each other. For example, portions of the first external electrode 4100 which extend to the lower and upper portions of the stacked body 1000 may be formed to overlap predetermined regions of the internal electrodes 200. In addition, portions of the second external electrode 4200 which extend to the lower and upper portions of the stacked body 1000 may also be formed to overlap predetermined regions of the internal electrodes 200. For example, the portions of the second external electrode 4200 which extend to the lower and portion of the stacked body 1000 may be formed so as to overlap the first and eighth internal electrodes 201 and 208. That is, at least one of the external electrodes 4000 may extend to the upper and lower surfaces of the stacked body 1000, and at least one of the extended portions may be formed so as to partially overlap the internal electrodes 200. At this point, the areas of the internal electrodes 200 overlapping the external electrodes 4000 may each be within 1% to 10% of the total area of the internal electrodes 200. In addition, in the area of the external electrode 4000, the area formed on at least any one among the upper and lower surfaces of the stacked body 1000 may be increased by a plurality of times of processes.

Accordingly, a predetermined parasitic capacitance may be generated between the external electrodes 4000 and the internal electrodes 200 by overlapping the external electrodes 4000 and the internal electrodes 200. For example, the capacitance may be formed between the first and eighth internal electrodes 201 and 208 and the respective extended portions of the first and second external electrodes 4100 and 4200. Thus, the capacitance of the stacked element may be adjusted by adjusting the overlap areas of the external electrodes 4000 and the internal electrodes 200. However, since the capacitance of the stacked element affects the antenna performance inside an electronic device, the distribution of the capacitance in the stacked element is maintained within 20%, favorably, within 5%. However, when the permittivities of the first and 11th sheets 101 and 111, which are provided between the internal electrodes 200 and the external electrodes 4000, are high, the parasitic capacitance increases. However, since the permittivities of the first and 11th sheets 101 and 111 positioned at the outermost portion are lower than the permittivties of the other sheets 102 to 110, the influence of the parasitic capacitance between the internal electrodes 200 and the external electrodes 4000 may be reduced. That is, since the permittivities of the first and 11th sheets 101 and 111 are low, the parasitic capacitance between the internal electrodes 200 and the external electrodes 4000 may be reduced.

5. Surface Reforming Member

Meanwhile, a surface reforming member (not shown) may be formed on at least one surface of the stacked body 1000. This surface reforming member may be formed by distributing, for example, oxides on the surfaces of the stacked body 1000 before forming the external electrodes 4000. Here, the oxides may be dispersed and distributed on the surfaces of the stacked body 1000 in a crystalline state or a non-crystalline state. The surface reforming member may be distributed on the surfaces of the stacked body 1000 before a plating process when forming the external electrodes 4000 through a plating process. That is, the surface reforming member may be distributed before forming portions of the external electrodes 4000 through a printing process, and may also be distributed before performing a plating process after the printing process. Of course, when the printing process is not performed, the plating process may be performed after distributing the surface reforming member. In this case, the surface reforming member distributed on the surfaces may be at least partially melted.

Meanwhile, at least a portion of the surface reforming member may be uniformly distributed on the surfaces of the stacked body 1000 in the same size, or at least a portion thereof may be irregularly distributed in different sizes. In addition, a recessed portion may be formed on at least a portion of the surfaces of the stacked body 1000. That is, a protruding portion is formed by forming the surface reforming member, and the recessed portion may also be formed by digging at least a portion of the region where the surface reforming member has not been formed. At this point, at least a portion of the surface reforming member may be formed to be deeper than the surface of the stacked body 1000. That is, a predetermined thickness of the surface reforming member is embedded in the stacked body 1000 in a predetermined depth, and the remaining thickness may be formed to be higher than the surface of the stacked body 1000. In this case, the thickness embedded in the stacked body 1000 may be approximately 1/20 to 1 of the average diameter of the oxide particles. That is, all the oxide particles may be embedded into the stacked body 1000, or at least a portion thereof may be embedded. Of course, the oxide particles may be formed only on the surfaces of the stacked body 1000. Thus, the oxide particles may be formed in semi-spherical shapes on the surface of the stacked body 1000, and may also be formed in spherical shapes. In addition, the surface reforming member, as described above, may be partially distributed on the surfaces of the stacked body 1000, or may also be distributed on at least one region in a film shape. That is, the oxide particles are distributed in island shapes on the surface of the stacked body, so that the surface reforming member may be formed. That is, oxides in a crystalline state or in a non-crystalline state may be distributed so as to be spaced apart from each other on the surfaces of the stacked body 1000 in island shapes, and thus, at least a portion of the surfaces of the stacked body 1000 may be exposed. In addition, the oxides and the surface reforming member may be formed in films in at least one region, and may be formed in island shapes in at least a portion. That is, at least two or more oxide particles may be coagulated or adjacent oxide particles may be connected to form a film shape. However, even when the oxides are present in a particle state or two or more particles are coagulated or connected, at least a portion of the surface of the stacked body 1000 may be exposed to the outside by the surface reforming member.

At this point, the total area of the surface reforming member may be, for example, 5% to 90% of the entire surface area of the stacked body 1000. A plating smudging phenomenon on the surfaces of the stacked body 1000 may be controlled according to the area of the surface reforming member, but when the surface reforming member is excessively formed, the contact between conductive patterns inside the stacked body 1000 and the external electrodes 4000 may be difficult. That is, when the surface reforming member is formed in an area of less than 5% of the surface area of the stacked body 1000, it is difficult to control the plating smudging phenomenon, and when formed in an area greater than 90%, the conductive patterns inside the stacked body 1000 and the external electrodes 4000 do not come into contact with each other. Thus, it is desirable to form the surface reforming member in an area such that the plating smudging phenomenon may be controlled and the conductive pattern inside the stacked body 1000 and the external electrode 4000 may come into contact with each other. To this end, the surface reforming member may be formed in an area of 10%-90% of the surface area of the stacked body 1000, favorably in an area of 30% to 70%, and more favorably in an area of 40% to 50%. At this point, the surface area of the stacked body 1000 may be the surface area of one surface, or may be the surface area of the six surfaces of the stacked body 1000 which forms a hexahedron. Meanwhile, the surface reforming member may be formed in a thickness of no greater than 10% of the thickness of the stacked body 1000. That is, the surface reforming member may be formed in a thickness of 0.01% to 10% of the thickness of the stacked body 1000. For example, the surface reforming member may be present at a size of 0.1-50 μm, and accordingly, the surface reforming member may be formed in a thickness of 0.1-50 μm from the surfaces of the stacked body 1000. That is, the surface reforming member may be formed in a thickness of 0.1-50 μm from the surface of the stacked body 1000 excluding the region embedded into the surface of the stacked body 1000. Thus, when including the thickness embedded into the stacked body 1000, the surface reforming member may have the thickness larger than 0.1-50 μm. When the surface reforming member is formed in a thickness of less than 0.01% of the thickness of the stacked body 1000, it is difficult to control the plating smudging phenomenon, and when formed in a thickness of greater than 10% of the thickness of the stacked body 1000, the conductive pattern inside the stacked body 1000 and the external electrodes 4000 do not come into contact with each other. That is, the surface reforming member may have various thicknesses according to material characteristics (conductivity, semi-conductivity, insulability, magnetism, etc.) of the stacked body 1000, and to the size, distributed amount, coagulation of oxide powder.

As such, a surface reforming member is formed on the surface of the stacked body 1000, so that at least two regions having different components may be present on the surface of the stacked body 1000. That is, mutually different components may be detected in the region in which the surface reforming member has been formed and in the region in which the surface reforming member has not been formed. For example, in the region in which the surface reforming member has been formed, a component due to the surface reforming member, that is, oxides may be present, and in the region in which the surface reforming member has not been formed, a component due to the stacked body 1000, that is, the component of the sheets may be present. As such, before the plating process, the surface reforming member is distributed on the surface of the stacked body 1000, so that roughness can be applied to the surface of the stacked body 1000 to reform the surface. Accordingly, the plating process may be uniformly performed, and thus, the shapes of the external electrodes 4000 may be controlled. That is, on the surface of the stacked body 1000, the resistance of at least one region may be different from those of the other regions, and when a plating process is performed in an unstable resistance state, uneven growth of a plated layer may be caused. In order to solve such the problem, the surface of the stacked body 1000 may be reformed by distributing particle-state or melt-state oxides on the surface of the stacked body 1000, and the growth of the plated layer may be controlled.

Here, at least one of, or example, Bi₂O₃, BO₂, B₂O₃, ZnO, Co₃O₄, SiO₂, Al₂O₃, MnO, H₂BO₃, Ca(CO₃)₂, Ca(NO₃)₂, or CaCO₃ may be used as the particle-state or melted-state oxides for uniformizing the surface resistance of the stacked body 1000. Meanwhile, the surface reforming member may also be formed on at least one sheet in the stacked body 1000. That is, the conductive patterns having various shapes on the sheets may also be formed through a plating process, and the shapes of the conductive patterns may be controlled by forming the surface reforming member.

As described above, in the first example of exemplary embodiments, at least one among the plurality of sheets 100 constituting the stacked body 1000 may be formed of a material having a relative permittivity and a rate of TCC change which are different from those of the other sheets. For example, at least one among the sheets 100 constituting the capacitor part 2000 may be formed of a material having a relative permittivity and a rate of TCC change which are different from those of the other sheets. Thus, a stacked element having an almost theoretic TCC may be achieved. In addition, the thicknesses of the sheets having different relative permittivities and TCCs, the overlap areas of the internal electrodes formed to contact the sheets, and the like are adjusted, and thus, the proportion of the capacitance due to the adjustment in the total capacitance is adjusted and the TCC can be finely adjusted.

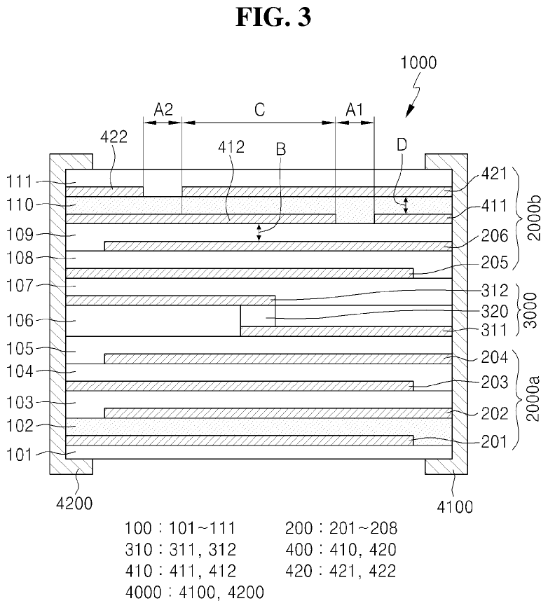

FIG. 3 is a cross-sectional view of a stacked element in accordance with a second example of exemplary embodiments.

Referring to FIG. 3, a stacked element in accordance with a second example of exemplary embodiments may include: a stacked body 1000 in which a plurality of sheets 100 (101 to 111) are stacked; at least one capacitor part 2000 (2000a and 2000b) provided inside the stacked body 1000 and provided with a plurality of internal electrodes 200 (201 to 206); an overvoltage protecting part 3000 which is provided with at least one discharge electrode 310 (311 and 312) and an overvoltage protection layer 320 to protect an overvoltage such as an ESD voltage; and diffusion prevention electrodes 400 (410 and 420) provided inside the stacked body 1000. Here, at least any one sheet among the plurality of sheets 100, for example, the 10th sheet 110 formed between the diffusion prevention electrodes 400, may have a different rate of TCC change from the other sheets. In addition, the 10th sheet 110 may have different relative permittivity than the other sheets. The diffusion prevention electrode 400 may be formed in order to prevent the materials of the sheet provided therebetween, that is, the 10th sheet 110 having the different rate of TCC change and relative permittivity from the other sheets, from being dispersed to the other sheets, or the materials of the other sheets from being dispersed to the 10th sheet 110. That is, the second example of exemplary embodiments is different from the first example of exemplary embodiments by including the diffusion prevention electrodes 400, and the second example of exemplary embodiments will be described below centering on the content distinguished from the first exemplary embodiment.

At least the 10th sheet 110 may have a different rate of TCC change and a different relative permittivity from the other sheets 101 to 109 and 111. For example, the 10th sheet 110 may be formed of COG, and the other sheets 101 to 109 and 111 may be formed of X7R. In addition, the 10th sheet 110 may be formed in the same thickness as the other sheets 101 to 109 and 111, or formed in the different thickness. When the 10th sheet 110 is formed in a different thickness than the other sheets 101 to 109 and 111, the 10th sheet 110 may be formed to be thicker or thinner than the other sheets 101 to 109 and 111.

The diffusion prevention electrodes 400 are formed so as to be in contact with, the upper and lower portions of at least one sheet, for example, the 10th sheet 110, having different relative permittivity and different rate of TCC change than the other sheets. At this point, one or more of the diffusion prevention electrodes 400 may be formed in a shape spaced apart a predetermined distance from each other on the same plane. For example, the diffusion prevention electrodes 400 may include first and second diffusion prevention electrodes 410 and 420, the first diffusion prevention electrode 410 may include 1a and 1b diffusion prevention electrodes 411 and 412 which are formed to be spaced apart a predetermined distance from each other on the ninth sheet 109, and the second diffusion prevention electrode 420 may include 2a and 2b diffusion prevention electrodes 421 and 422 which are formed to be spaced apart a predetermined distance from each other on the 10th sheet 110. In addition, the 1a and 1b diffusion prevention electrodes 411 and 412 are respectively connected to the first and second external electrodes 4100 and 4200, and the 2a and 2b diffusion prevention electrodes 421 and 422 are respectively connected to the first and second external electrodes 4100 and 4200. For example, the 1a and 2a diffusion prevention electrodes 411 and 421 are connected to the first external electrode 4100, and the 1b and 2b diffusion prevention electrodes 412 and 422 are connected to the second external electrode 4200. At this point, as illustrated in FIG. 3, the regions provided to be spaced apart the predetermined distance are provided to be offset with respect to each other, and since the 1b diffusion prevention electrode 412 and the 2a diffusion prevention electrode 421 partially overlap, capacitance is formed between the 1b diffusion prevention electrode 412 and the 2a diffusion prevention electrode 421. However, the first and second diffusion prevention electrodes 410 and 420 are formed so that the regions spaced apart the predetermined distance do not overlap each other. That is, when the regions, spaced apart the predetermined distance in the first and second diffusion prevention electrodes 410 and 420, overlap each other, capacitance is not formed between the first and second diffusion prevention electrode 410 and 420, and therefore the diffusion prevention electrodes 410 and 420 are formed so that the spaced apart regions do not overlap. As such, the diffusion prevention electrodes 400 which are spaced apart a predetermined distance on the same plane so as to be in contact with the 10th sheet 110 having the different relative permittivity and rate of TCC change than the other sheets, and thus, the materials constituting the 10th sheet 110 may be prevented from being dispersed to the other sheets, or the materials of the other sheets may be prevented from being dispersed to the 10th sheet 110. Also, undesired change in the rate of TCC change may be prevented by preventing the diffusion of materials having different relative permittivities and different rates of TCC change. That is, when at least two materials having different relative permittivities and different rates of TCC change are dispersed to each other, a characteristic similar to the undesired change in TCC due to mixing in related arts may occur, and this can be prevented by forming the diffusion prevention electrodes 400.

Meanwhile, the distance A between the diffusion prevention electrodes 400 formed on the same plane may be greater than or equal to the thickness B of the other sheets 101 to 104 and 106 to 109 of the capacitor part 2000. That is, distance A1 between the 1a and 1b diffusion prevention electrodes 411 and 412 and distance A2 between the 2a and 2b diffusion prevention electrodes 421 and 422 may be greater than or equal to the thickness B of the sheets 101 to 104 and 106 to 109 of the capacitor part 2000. The distance A between the diffusion prevention electrodes 400 are formed to be greater than or equal to the thickness B of the sheets 101 to 104 and 106 to 109, and thus, a decrease in the withstanding voltage may be prevented, and the control of the withstanding voltage may be easily performed. That is, the withstanding voltage may be adjusted by the distance between the internal electrodes 201 to 206 of the capacitor part 2000, and the greater the distance between the internal electrodes 201 to 206, that is, the distance between the sheets, the greater the withstanding voltage may be. However, when the distance A between the diffusion prevention electrodes 400 formed on the same plane is smaller than the distance B between the sheets of the capacitor part 2000, the withstanding voltage may be lowered, and the adjustment of the withstanding voltage may be difficult. That is, the diffusion prevention electrodes 400 are spaced apart from each other on the same plane and horizontally faces each other along a line, and the internal electrodes 200 face each other surface-to-surface in the vertical direction. Therefore, the withstanding voltage between the internal electrodes may be higher, but when the distance A between the diffusion prevention electrodes 400 is smaller than the distance B between the internal electrodes, the withstanding voltage may be reduced. Thus, the withstanding voltage is not reduced only when the distance A between the diffusion prevention electrodes 400 are larger than or equal to the distance B between the internal electrodes. Meanwhile, any one among the remaining sheets 101 to 104 and 106 to 109 of the capacitor part 2000 excluding the 10th sheet 110 may have a different thickness, and the distance A between the diffusion prevention electrodes 400 formed to be spaced apart from each other on the same plane may be larger than or equal to the thickness of the sheet having the smallest thickness. Meanwhile, the distance between the 1a and 1b diffusion prevention electrodes 411 and 412 and the distance between the 2a and 2b diffusion prevention electrodes 421 and 422 may be the same or different, and the distance A between the diffusion prevention electrodes 400 having small distance may be large than or equal to the smallest thickness among the other sheets 101 to 104 and 106 to 109 of the remaining sheets of the capacitor part 2000.

In addition, capacitance may be formed between the diffusion prevention electrodes 400 spaced apart from each other in the vertical direction. That is, the 1a diffusion prevention electrodes 411 and the 2b diffusion prevention electrodes 422 which are connected to mutually different external electrodes 4000 may overlap by a predetermined area, and the capacitance therebetween may be adjusted according to the overlap area therebetween. That is, when the overlap area is large, the capacitance may increase, and when the overlap area is small, the capacitance may decrease. In addition, according to the thickness D of the 10th sheet 210, the capacitance between the diffusion prevention electrodes 400 may be adjusted.

Thus, the withstanding voltage may be adjusted according to the distance A between the diffusion prevention electrodes 400 formed on the same plane and the thickness B of the sheets 100 of the capacitor part 2000, and the capacitance is adjusted according to the thickness D of at least one sheet 110 formed of different material from the overlap area C of the diffusion prevention electrode. Thus, the rate of TCC change may be finely adjusted.

### Comparative Examples

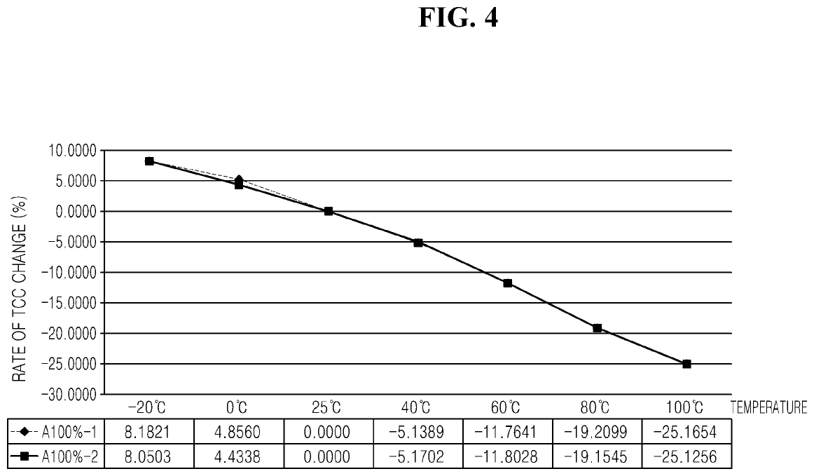

FIGS. 4 to 10 are graphs of rates of TCC change according to related examples.

In the related examples, rates of TCC change were measured by using a material A having the relative permittivity of 800 and the negative rate of TCC change of 15% and a material B having the relative permittivity of 80 and the positive rate of TCC change of 1%. Here, the material A is X7R, and the material B is COG. In the related examples, measurements were performed by using two respective samples, and the measured values were displayed in the lower sides of the graphs.

FIG. 4 is graph illustrating rates of TCC change according to the temperature of the material A having the relative permittivity of 800 and the negative rate of TCC change of 15%, that is, X7R, and illustrates a negative characteristic with which the rate of TCC change decreases according to temperature from −20° C. to 100° C.

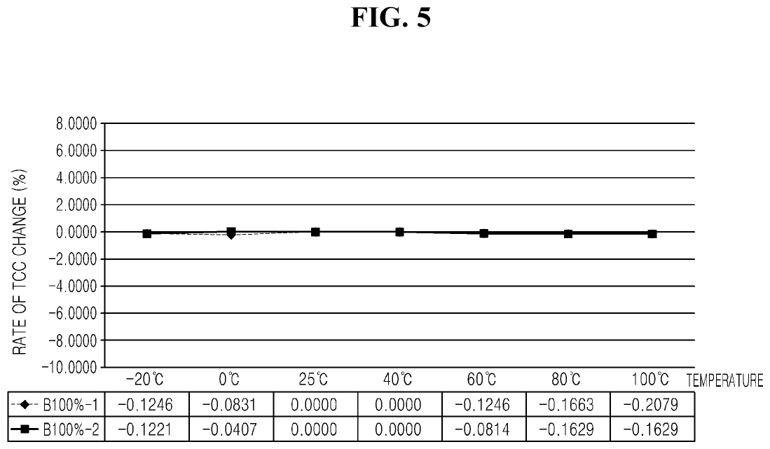

FIG. 5 is graph illustrating rates of TCC change according to the temperature of the material A having the relative permittivity of 80 and the positive rate of TCC change of 1%, that is, COG, and illustrates a positive characteristic with which the rate of TCC change are almost constant but slightly increases according to temperature from −20° C. to 100° C.

As described above, when adding, that is, mixing two materials having a negative TCC and a positive TCC, it was theoretically expected that the relative permittivity was low mainly due to tendency of the material having high relative permittivity and a large rage of TCC change, and the more the added amount of the material having a low rate of TCC change, the lower the slope of the negative TCC.

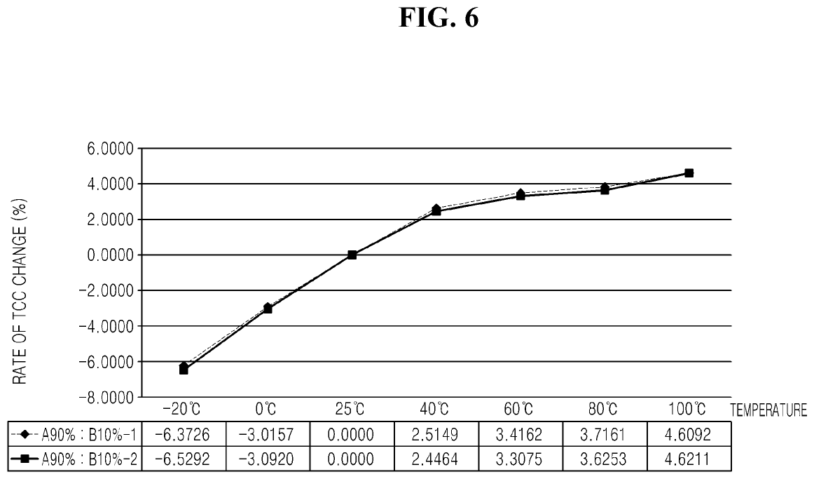

FIG. 6 is a TCC characteristic graph in case of mixing, at the ratio of 90:10, a material A having the relative permittivity of 800 and a negative characteristic and a material B having the relative permittivity of 80 and a positive characteristic. As illustrated, a positive characteristic appears in which the rate of TCC change increases according to temperature from −20° C. to 100° C. That is, it was theoretically expected that since the material having the positive characteristic was added in reduced amount, the slope of the graph decreased while maintaining the negative characteristic, but unlike the expectation, a characteristic appeared in which the slope was large while having the positive characteristic.

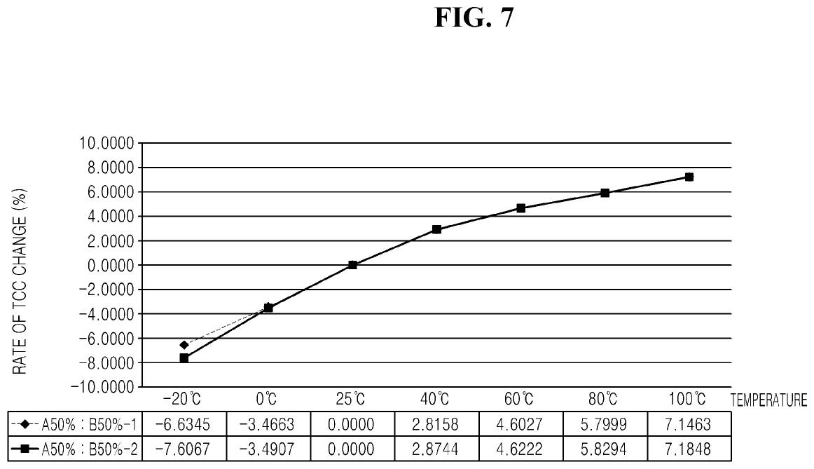

FIG. 7 is a TCC characteristic graph in case of mixing, at the ratio of 50:50, a material A having the relative permittivity of 800 and a negative characteristic and a material B having the relative permittivity of 80 and a positive characteristic. As illustrated, a positive characteristic appears in which the rate of TCC change increases according to temperature from −20° C. to 100° C. That is, it was theoretically expected that since the material having the positive characteristic was added in the same amount, the slope of the graph decreased while maintaining the negative or positive characteristic, but unlike the expectation, a characteristic appeared in which the slope was large while having the positive characteristic.

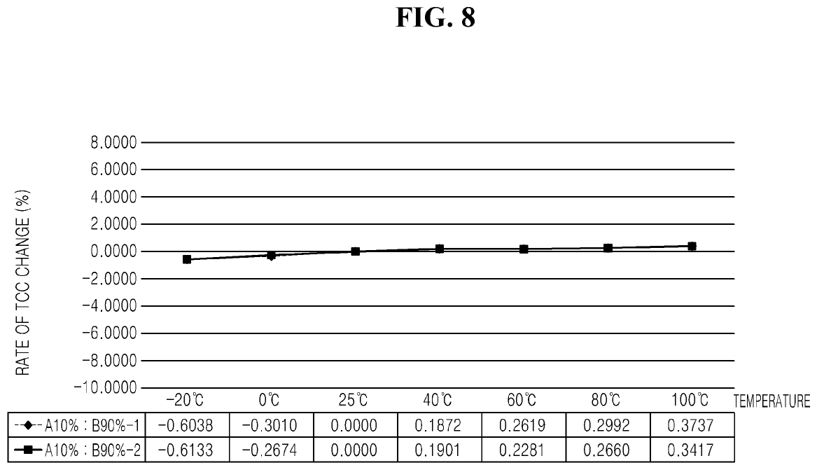

FIG. 8 is a TCC characteristic graph in case of mixing a material A having the relative permittivity of 800 and a negative characteristic and a material B having the relative permittivity of 80 and a positive characteristic at the ratio of 10:90. As illustrated, a positive characteristic appears in which the rate of TCC change increases according to temperature from −20° C. to 100° C. That is, it was theoretically expected that since the material having the negative characteristic was added in less amount, a negative characteristic appeared, but unlike the expectation, a positive characteristic appeared.

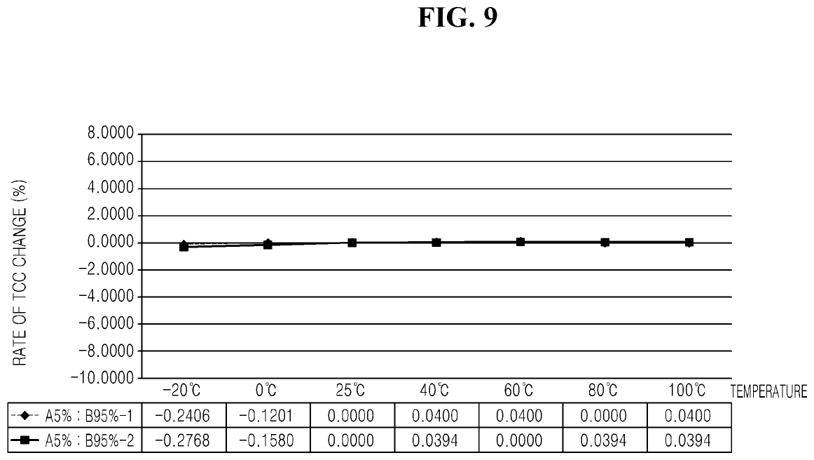

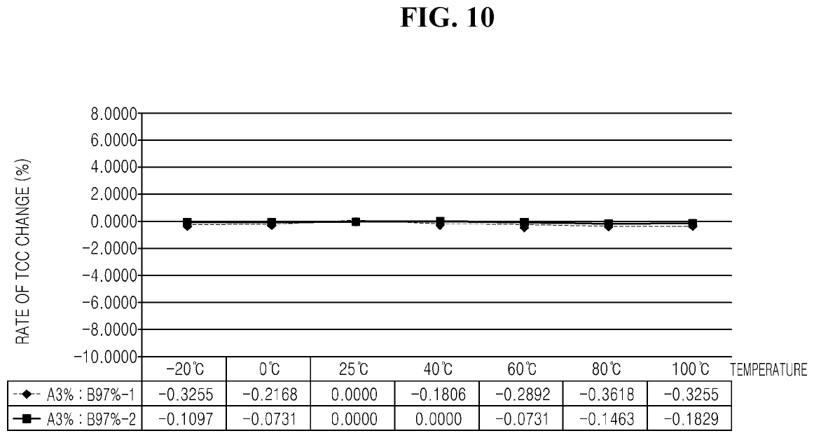

FIG. 9 is a TCC characteristic graph in case of mixing, at the ratio of 3:97, a material A having the relative permittivity of 800 and a negative characteristic and a material B having the relative permittivity of 80 and a positive characteristic. The rate of TCC change exhibits a positive characteristic of slight increase or decrease according to temperature as illustrated in FIG. 9, or exhibits a negative characteristic of slight decrease as illustrated in FIG. 10. That is, it was theoretically expected that since the material having the negative characteristic was added in less amount, a positive characteristic appeared, but unlike the expectation, the positive characteristic of slight increase or decrease, and the negative characteristic of slight decrease appeared.

### Examples

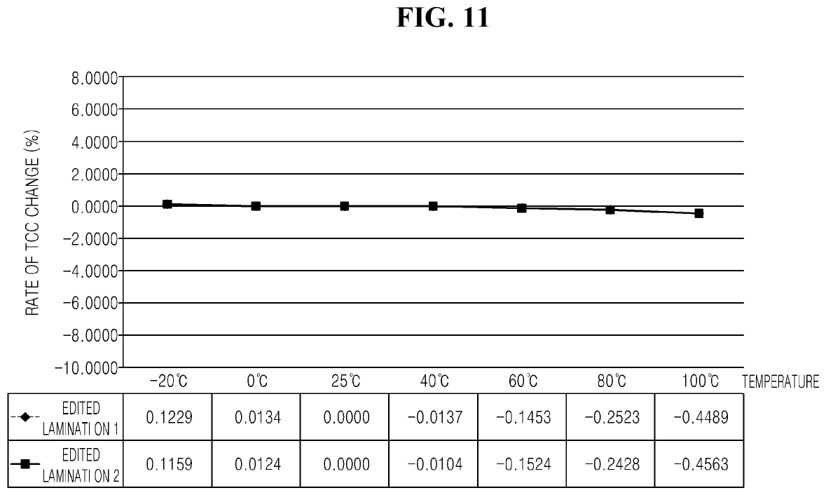

FIG. 11 is a TCC graph in accordance with an exemplary embodiment in which a material A having relative permittivity of 800 and a negative characteristic, and a material B having relative permittivity of 80 and a positive characteristic are edited and stacked. That is, a sheet formed of the material A and a sheet formed of the material B were stacked and the TCCs were measured. As illustrated in FIG. 11, due to the edited lamination in accordance with the exemplary embodiment, there appear a negative TCC, which is the characteristic of the material B, and a rate of TCC, which is the small rate of change characteristic of the material A. That is, a characteristic of a rate of TCC change similar to the theory may be obtained by edited lamination of the material A and the material B.

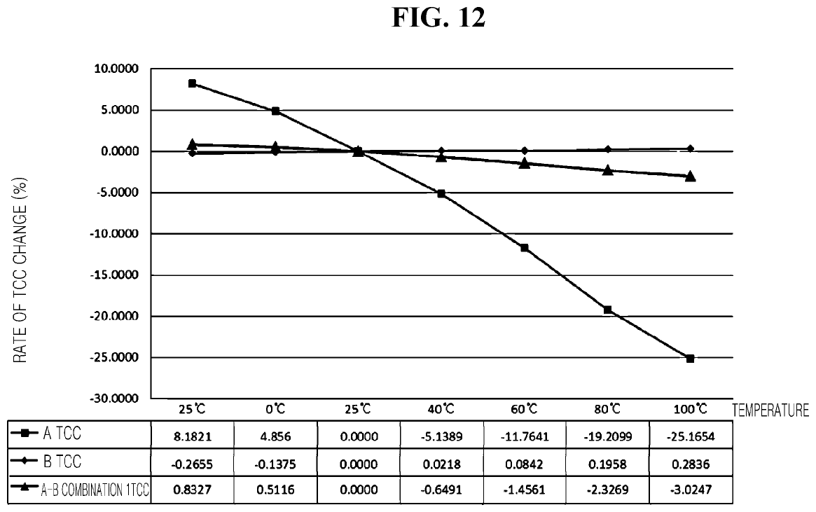

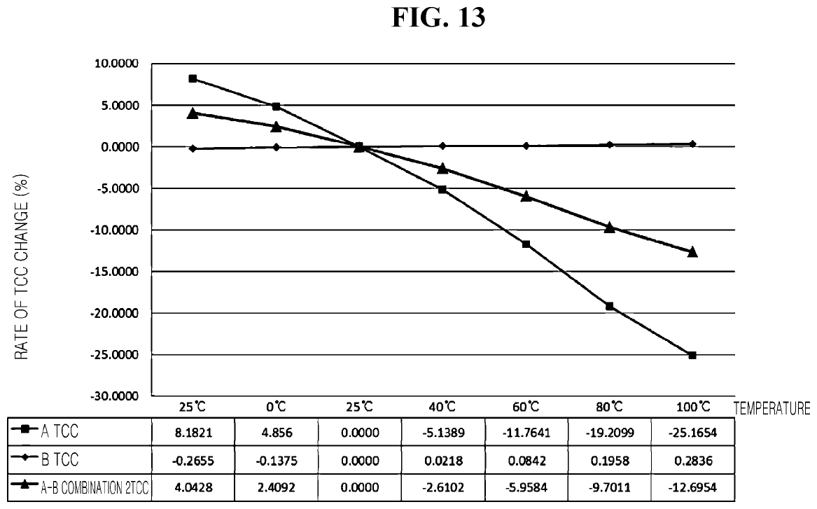

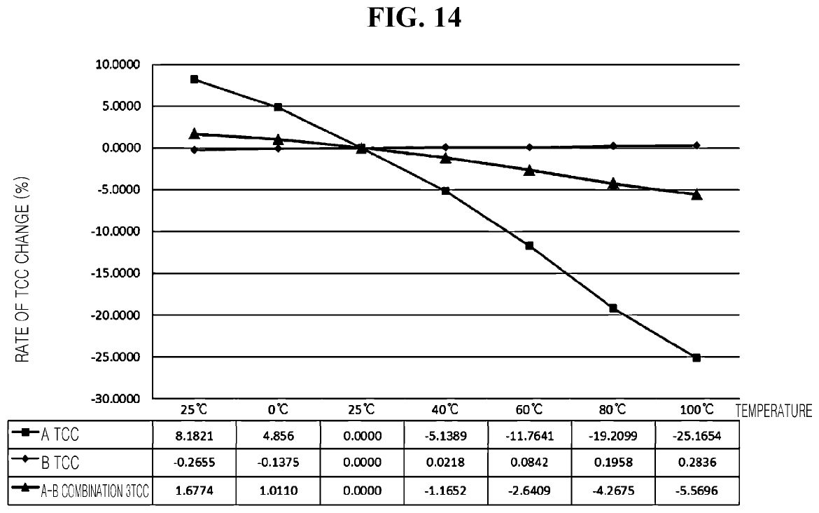

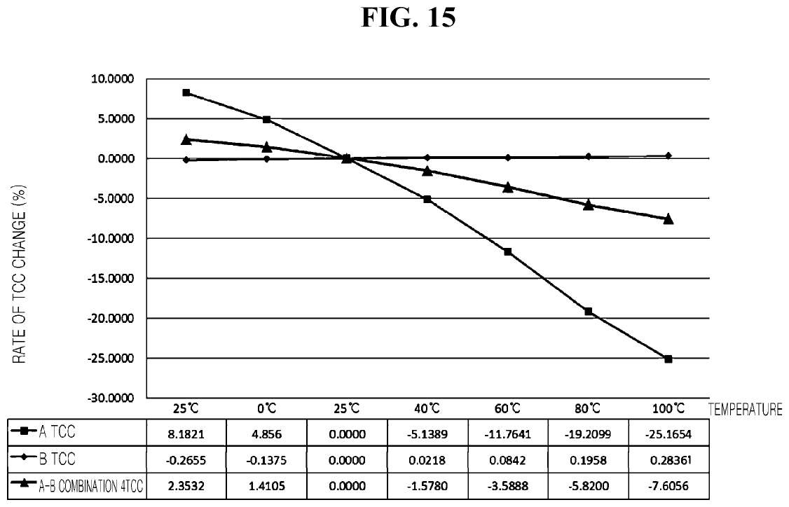

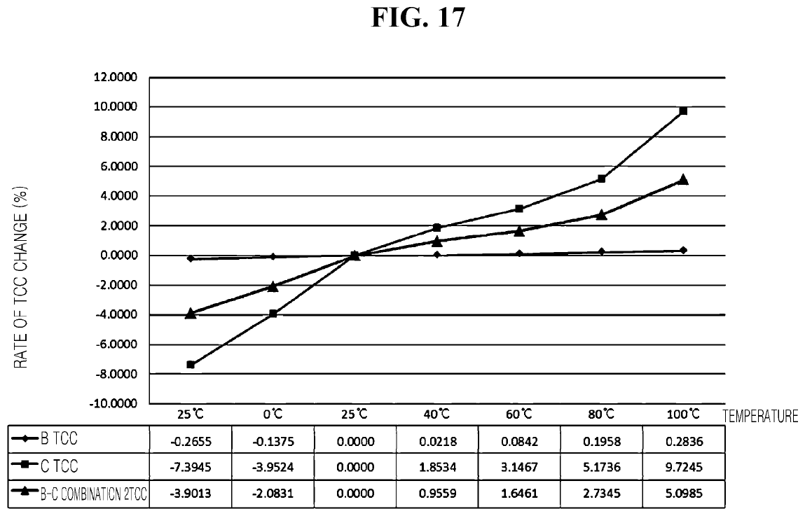

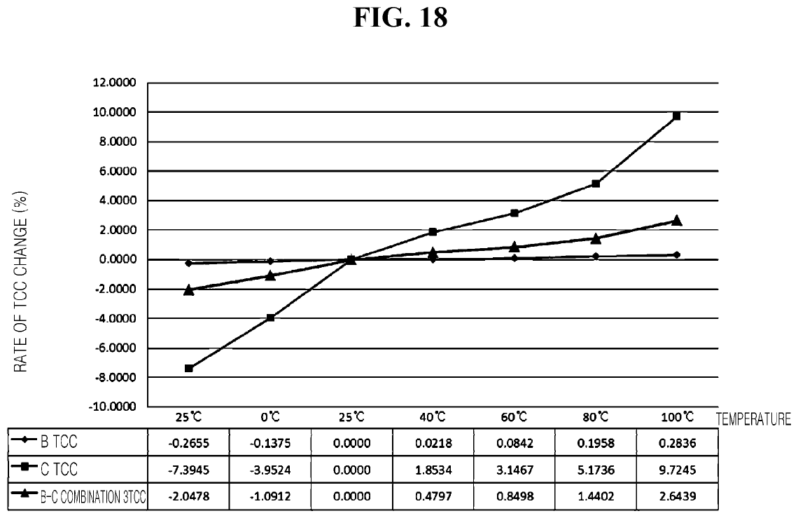

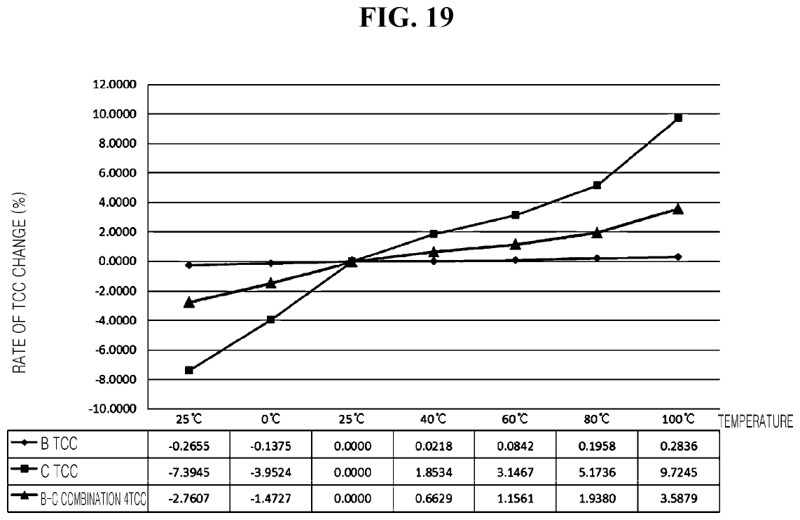

Meanwhile, in the exemplary embodiment, the rate of TCC change and the capacitance may be adjusted according to the overlap areas of the internal electrodes, the thicknesses of sheets, and the like. Such rates of TCC change according to the overlap areas and the thicknesses of sheets will be described below with reference to Table 1 and FIGS. 12 to 19.

Table 1 is a table illustrating: theoretical capacitance and actual capacitance according to three materials having mutually different relative permittivities and TCC characteristics, the overlap areas of the internal electrodes due to edited lamination of the materials, and the thicknesses of sheets; and rates of change at a predetermined temperature (60° C.). That is, Table 1 illustrates a characteristic due to the respective characteristics of a material A having relative permittivity of 800 and a negative TCC, a material B having relative permittivity of 80 and a positive TCC, and a material C having relative permittivity of 1000 and a positive TCC, and the edited lamination thereof, and FIGS. 12 to 19 illustrate the same. Here, the material A and C are X7R, and the material B is COG. That is, X7R may be a mixture of one or more among BaTiO₃, Co₃O₄, La₂O₃, Nb₂O₅, ZnO, Bi₂O₃, NiO, Cr₂O₃, BaCO₃, and WO, and the relative permittivity and the rate of TCC change may be adjusted by the added amount or relative ratio of the materials. Accordingly, X7Rs having different relative permittivities and TCC change were used for A and C.

When comparing the combinations 1 to 4 of the material A and the material B, it may be understood that the larger the overlap area of A, the larger the theoretical capacitance and the actual capacitance. In addition, it may be understood that when the thickness of A increases, the theoretical and actual capacitances decrease. The corresponding graphs are shown in FIGS. 12 to 15.

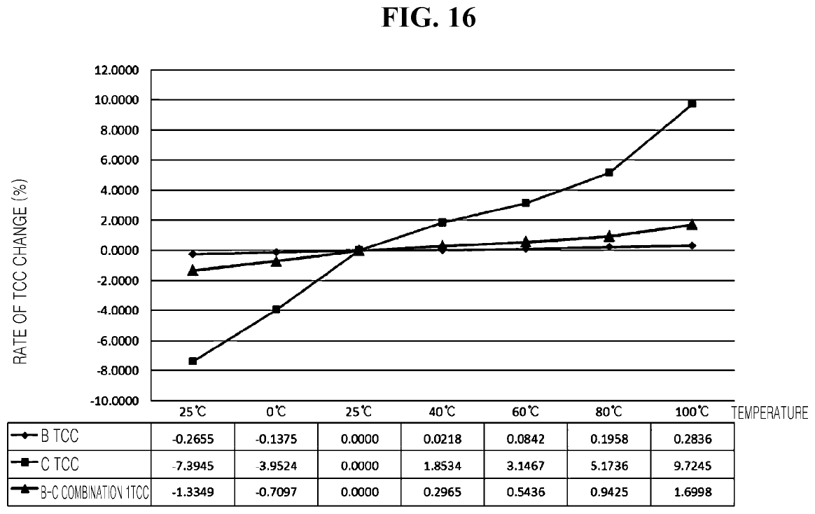

When comparing the combinations 1 to 4 of the material B and the material C, it may be understood that the larger the overlap area of C, the larger the theoretical and actual capacitance. In addition, it may be understood that when the thickness of C increases, the theoretical and actual capacitances decrease. The corresponding graphs are shown in FIGS. 16 to 19.

TABLE 1

| | | | | Sheet | | | Rate of | |
|---|---|---|---|---|---|---|---|---|
| | Relative | | Overlap | thickness | Theoretical | Actual | change | Change |
| Composition | permittivity | TCC | area(mm²) | (μm) | capacitance | capacitance | (%)@60° C. | content |
| A | 800 | negative | 0.234 | 17 | 97.4 pF | 92.3 pF | −11.76% | |
| B | 80 | positive | 2.182 | 17 | 90.9 pF | 84.7 pF | 0.08% | |
| C | 1000 | positive | 0.185 | 17 | 96.3 pF | 90.1 pF | 3.15% | |
| A-B | 800 | negative | 0.030 | 17 | 94.3 pF | 91.7 pF | −1.46% | Overlap |
| combination | 80 | | 1.967 | 17 | (A/(A + B) = | | | area |
| 1 | | | | | 13%) | | | |
| A-B | 800 | negative | 0.120 | 17 | 97.6 pF | 94.3 pF | −5.96% | Overlap |
| combination | 80 | | 1.146 | 17 | (A/(A + B) = | | | area |
| 2 | | | | | 51%) | | | |
| A-B | 800 | negative | 0.800 | 25.5 | 99.3 pF | 97.8 pF | −2.64% | Overlap |
| combination | 80 | | 1.852 | 17 | (A/(A + B) = | | | area and |
| 3 | | | | | 22%) | | | sheet |
| | | | | | | | | thickness |
| A-B | 800 | negative | 0.154 | 34 | 100.2 pF | 94.5 pF | −3.59% | Overlap |
| combination | 80 | | 1.637 | 17 | (A/(A + B) = | | | area and |
| 4 | | | | | 31%) | | | sheet |
| | | | | | | | | thickness |
| B-C | 80 | positive | 1.967 | 17 | 96.6 pF | 91.3 pF | 0.54% | Overlap |
| combination | 1000 | | 0.030 | 18 | (C/(B + C) = | | | area |
| 1 | | | | | 15%) | | | |
| B-C | 80 | positive | 1.146 | 17 | 106.7 pF | 100.2 pF | 1.65% | Overlap |
| combination | 1000 | | 0.120 | 18 | (C/(B + C) = | | | area |
| 2 | | | | | 51%) | | | |
| B-C | 80 | positive | 1.852 | 17 | 103.3 pF | 98.4 pF | 0.85% | Overlap |
| combination | 1000 | | 0.800 | 27 | (C/(B + C) = | | | area and |
| 3 | | | | | 25%) | | | sheet |
| | | | | | | | | thickness |
| B-C | 80 | positive | 1.637 | 17 | 106.6 pF | 101.9 pF | 1.16% | Overlap |
| combination | 1000 | | 0.154 | 36 | (C/(B + C) = | | | area and |
| 4 | | | | | 35%) | | | sheet |
| | | | | | | | | thickness |

The above-mentioned stacked element in accordance with exemplary embodiments may be provided between a metal case 10 and an internal circuit 20 of an electronic device as shown in FIG. 20. That is, any one of the external electrodes 4000 may be connected to an internal circuit 20, and the other may be connected to the metal case 10 of the electronic device. For example, a first external electrode 4100 may be connected to the internal circuit 20, and a second external electrode 4200 may be connected to the metal case 10. At this point, a ground terminal may be provided inside the internal circuit 20, and a ground terminal may be provided in a region other than the internal circuit 20. For example, the ground terminal may be provided between the metal case 10 and the internal circuit 20. Accordingly, the stacked element may be connected to the ground terminal through the internal circuit 20, and be connected in parallel between the internal circuit 20 and the ground terminal. Meanwhile, at least one passive element, such as a diode, may be provided between the stacked element and the internal circuit 20. In addition, as shown in FIG. 21, a contact part 30 using a conductive material such as a contactor, a conductive gasket or the like may further be provided between a second external electrode 4200 and a metal case 10. Accordingly, a shock voltage transmitted to the metal case 10 from a ground terminal of an internal circuit 20 may be blocked, and an overvoltage such as an ESD voltage applied from the outside to the internal circuit 20 may be bypassed to the ground terminal. That is, in the stacked element of an exemplary embodiment, current may not flow between the external electrodes 4000 at the rated voltage and a shock voltage, and current flows at the ESD voltage through a protective layer 320, and an overvoltage is bypassed to the ground terminal. Meanwhile, the stacked element may have a discharge start voltage higher than the rated voltage and lower than the ESD voltage. For example, the stacked element may have the rated voltage of 100V to 240V, the shock voltage may be the same or higher than the operation voltage of a circuit, and the ESD voltage generated by external electrostatic electricity or the like may be higher than the shock voltage. In addition, a communication signal from the outside, that is, an AC frequency may be transmitted to the internal circuit 20 through a capacitor formed between internal electrodes 200. Accordingly, a communication signal from the outside may be applied even when the metal case 10 is used as an antenna without providing a separate antenna. Consequently, in the stacked element in accordance with an exemplary embodiment, it is possible to block the shock voltage, bypass the ESD voltage to the ground terminal, and apply a communication signal to the internal circuit.

In addition, in the stacked element of the exemplary embodiment, a plurality of sheets having high insulating characteristics are stacked to form a stacked body 1000, and thus, an insulating resistance state may be maintained so that a leak current may not flow when a shock voltage of, for example, 310 V is introduced toward the metal case 10 in the internal circuit 20 due to a defective charger. In addition, the protective layer 320 also bypasses an overvoltage when the overvoltage is introduced to the internal circuit 20 from the metal case 10, and may maintain a high insulation resistive state without damage to the element. That is, the protective layer 320 is formed in a porous structure, and includes a porous insulating material that causes current to flow through fine pores, and further includes a conductive material which lowers an energy level and converts electrical energy into thermal energy, and may thus protect a circuit by bypassing an overvoltage introduced from the outside. Accordingly, the stacked element is not electrically broken down even by an overvoltage, is thereby provided in the electronic device provided with the metal case 10, and may continuously prevent a shock voltage caused in a defective charger from being transmitted to a user through the metal case 10 of the electronic device. Meanwhile, general multilayer capacitance circuit (MLCC) is an element which protects a shock voltage, but is weak to an ESD voltage, and thus, when repeatedly applying an ESD voltage, spark is generated due to a leak point caused by charging and an element breakdown phenomenon may be caused. However, in the exemplary embodiment, the protective layer 320 is formed which includes a porous insulating material between the internal electrodes 200, so that an overvoltage is bypassed through the protective layer 320, and thus, at least a portion of the main body 100 is not broken.

In addition, the permittivity or the relative permittivity of the overvoltage protection part 3000 is increased to be higher than that of the capacitor part 2000, and thus, two conflicting characteristics of a high quality index and a low discharge start voltage may simultaneously be achieved. That is, the quality index may be improved by reducing the permittivity or the relative permittivity of the capacitor part 2000, and the discharge start voltage may be lowered by increasing the permittivity or the relative permittivity of the overvoltage protection part 3000. Accordingly, a stacked element in which the capacitor part 2000 and the overvoltage protection part 3000 are formed inside the stacked body 1000 may be used for antenna matching.

In addition, the external electrodes 4000 and the internal electrodes 200 may also be formed to overlap each other, and thus, predetermined parasitic capacitance may be generated between the external electrodes 4000 and the internal electrodes 200. Thus, the capacitance of the stacked element may be adjusted by adjusting the overlap areas of the external electrodes 4000 and the internal electrodes 200. However, since the capacitance of the stacked element affects the performance of an antenna inside the electronic device, the sheets 100 having high permittivity are used to favorably maintain the distribution of the capacitance of the stacked element within 5%. Accordingly, the higher the permittivities of the sheets 100, the greater the influence of the parasitic capacitance between the internal electrodes 200 and the external electrodes 4000. However, since the permittivities of the sheets positioned outermost are lower than those of the remaining sheets therebetween, the influence of the parasitic capacitance between the internal electrodes 200 and the external electrodes 4000 may be reduced.

In exemplary embodiments, a stacked element has been exemplarily described which is provided in an electronic device of a smartphone, protects the electronic devices from overvoltages such as an ESD voltage applied from the outside, and block leak current form the inside of the electronic device, and thereby protects a user. However, the stacked element of exemplary embodiments may be provided in various electronic devices aside from smartphones, and carries out at least two protective functions.

The present invention may, however, be embodied in different forms and should not be construed as limited to the embodiments set forth herein. That is, these exemplary embodiments are provided so that this disclosure will be thorough and complete, and fully convey the scope of the present disclosure to those skilled in the art, and the scope of the present disclosure should be understood by claims.

1. A stacked element comprising:
a laminate in which a plurality of sheets are stacked;
a capacitor part comprising a plurality of internal electrodes formed inside the laminate; and
an external electrode provided outside the laminate and connected to the internal electrode,
wherein at least one sheet among the plurality of sheets has a different temperature coefficient of capacitance (TCC) from the remaining sheets.

2. The stacked element of claim 1, wherein at least one sheet among the plurality of sheets has a different relative permittivity from the remaining sheets.

3. The stacked element of claim 2, wherein at least one sheet having the different TCC has a different relative permittivity from the remaining sheets.

4. The stacked element of claim 1, wherein a rate of TCC change is adjusted according to a thickness of the sheet having the different TCC and an overlap area of the internal electrode formed to be in contact with the sheet having the different TCC.

5. The stacked element of claim 1, further comprising diffusion prevention electrodes formed to be in contact with the sheet having the different TCC and be spaced apart a predetermined distance from each other on a same plane.

6. The stacked element of claim 5, wherein the diffusion prevention electrodes have, on the same plane, a spaced-apart distance greater than or equal to thickness of the remaining sheets.

7. The stacked element of claim 6, wherein a rate of TCC change is adjusted according to a thickness of the sheet having the different TCC and an overlap area of the diffusion prevention electrode.

8. The stacked element of claim 1 having a positive or negative rate of TCC change of no greater than 1%.

9. The stacked element of claim 8, further comprising at least one functional layer provided inside the laminate.

10. The stacked element of claim 9, wherein the functional layer comprises a resistor, a noise filter, an inductor, and an overvoltage protection part.

11. The stacked element of claim 10, wherein the overvoltage protection part comprises:
at least two discharge electrodes; and
at least one overvoltage protection layer provided between the discharge electrodes.

12. An electronic device comprising the stacked element set forth in claim 10.

13. The electronic device of claim 12, wherein the stacked element comprises a capacitor part and an overvoltage protection part, and is provided between a conductor contactable with a user and an internal circuit.

14. The electronic device of claim 13, wherein the stacked element transmits a communication signal and prevents electric shock or an overvoltage.

15. The electronic device of claim 13, further comprising: at least one conductive member provided between the conductor and the stacked element, wherein
the stacked element is connected to a ground terminal or connected to the ground terminal via a passive element.
